(19) United States
(12) Patent Application Publication
(10) Pub. No.: US 2016/0189513 A1
(43) Pub. Date: Jun. 30, 2016

(54) Situationally Aware Alarm

(71) Applicant: Google Inc., Mountain View, CA (US)

(72) Inventor: David Hendler Sloo, Menlo Park, CA (US)

(21) Appl. No.: 14/585,243

(22) Filed: Dec. 30, 2014

(51) Int. Cl. G08B 21/02; G08B 25/00

(52) U.S. Cl. CPC G08B 21/02; G08B 25/005

(57) ABSTRACT

A method and system for a situationally aware alarm. A physical status of a premises, such as a home, may be determined. An occupancy status of the premises may be determined. Sensor data from the premises may be collected. An event, such as a hazardous event, may be detected based on the sensor data. A notice may be generated based on the detected event, the physical status of the premises, and the occupancy status of the premises. A recipient may be determined based on the detected event, the physical status of the premises, and the occupancy status of the premises. The notice may be transmitted to the recipient.

### BACKGROUND

Certain existing devices detect simple artifacts of a dangerous situation and generate a generic response based upon that detection. For example, a smoke detector in a building detects the artifact smoke or a sprinkler system detects the artifact heat. The response of a smoke detector or a sprinkler system is to sound an alarm or activate one or more sprinklers. However, relying solely on such simple artifacts can lead to false alarms or no alarm when one is justified. For example, a smoke alarm can sound an alarm upon detecting some kinds of particulates in the air that are not related to a fire or other hazardous situation, such as emissions from normal cooking activities that generate airborne particulates, such as indoor grilling. Likewise, a sprinkler may fail to activate in the presence of a low intensity fire, such as a smoldering fire.

### BRIEF SUMMARY

According to an embodiment of the disclosed subject matter, a method may determine a physical status of a premises and an occupancy status of the premises. Sensor data about the premises may be collected and an event may be detected based on the collected sensor data. The method then may generate a notice based upon the detected event, the determined physical status of the premises, and the determined occupancy status of the premises.

According to another embodiment of the disclosed subject matter, a system may be comprised of at least one sensor and a processor in communication with the at least one sensor. The processor may be adapted and configured to determine a physical status of a premises, determine an occupancy status of the premises, collect sensor data about the premises, detect an event based upon the collected sensor data, and generate a notice based upon the detected event, the determined physical status of the premises, and the determined occupancy status of the premises.

According to another embodiment of the disclosed subject matter, means for determining a physical status of a premises and an occupancy status of the premises, collecting sensor data about the premises, detecting an event based upon the collected sensor data, and generating a notice based upon the detected event, the determined physical status of the premises, and the determined occupancy status of the premises.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a method of generating a notice according to an embodiment of the disclosed subject matter.

FIG. 2 shows a method according to an embodiment of the disclosed subject matter in which a recipient is identified.

FIG. 3 shows a system according to an embodiment of the disclosed subject matter.

FIG. 4A shows a sensor according to an embodiment of the disclosed subject matter.

FIG. 4B shows an example premises according to an embodiment of the disclosed subject matter.

FIG. 5A shows a sensor according to an embodiment of the disclosed subject matter.

FIG. 5B shows a sensor according to an embodiment of the disclosed subject matter.

FIG. 6A shows networked sensors according to an embodiment of the disclosed subject matter.

FIG. 6B shows networked sensors according to an embodiment of the disclosed subject matter.

FIG. 7 shows a computing device according to an embodiment of the disclosed subject matter.

FIG. 8 shows a networked arrangement according to an embodiment of the disclosed subject matter.

### DETAILED DESCRIPTION

The subject matter of this disclosure relates to a situationally aware notice (such as an alarm or a message) that can be tailored to reflect the particulars of a given situation. In particular, a notice can be generated based on particulars about the occupancy status of a premises, the physical status of the premises, sensor data, and an event relating to the premises. For example, a smart-home system (which may be part of or implemented with the components of a “smart-home environment” as discussed below) can determine that the occupancy status of a residence is “home” because at least some of the occupants are inside the residence. It can also determine that the cooktop in the kitchen of the residence is on. It can further detect an event by detecting a sudden rise in heat over the cooktop based on inputs from a heat sensor above the cooktop, and no significant increase in heat from other heat sensors mounted on the ceiling near, but not over, the cooktop. Based on these factors, the system may generate no notice, or may send a notice to a smartphone indicating that the cooktop has been turned on. On the other hand, if the system determines that there are no occupants (or anyone else) in the home and the rest of the inputs in the foregoing example are the same, the system can generate a message to the local fire department.

A premises can include any structure, subset of the structure, set of structures under common control or contiguous with the structure. It can also include any land or atmosphere that is located proximate to and above, below, within, or surrounding the structure. For example, a premises can include a home, a plot of land on which the home is located, an owner of the home's right of access to an alley running adjacent the plot of land, a storage shed located on a corner of the plot of land, a garage parking space located in a public garage building, an underground storage cellar located beneath the storage shed and a parking space on the street in front of the home. A premises may include structures other than residential homes, such as businesses, government complexes, medical facilities, public utilities, military bases, research facilities, and schools.

A physical status can include a set of one or more indicators, including: an open/close indicator, a lock/unlock indicator, a heating/cooling system indicator, an appliance indicator, a lighting indicator, a computer indicator, a network indicator, a power system indicator, a water system indicator, a gas system indicator, a security system indicator, and a robotic device indicator. An indicator can include data representing the state of a given component of a home environment. For example, the physical status of a premises can include which doors, windows, and other openings are open or closed or locked or unlocked, whether the heating or cooling system is running or off, whether an oven is on, which lights are on and the brightness of each, whether a computer is on or off, whether a wireless network or networked device is accessible at the premises, whether electricity is available at the premise, whether natural gas is available at the premises, and whether a security system is activated.

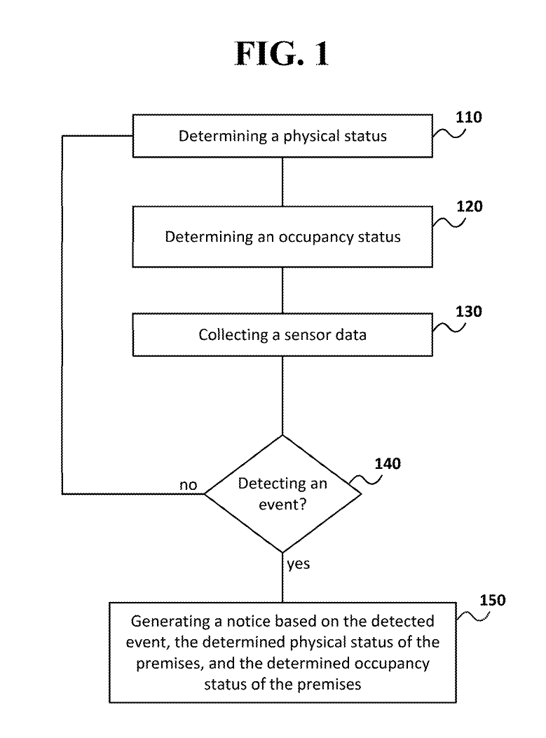

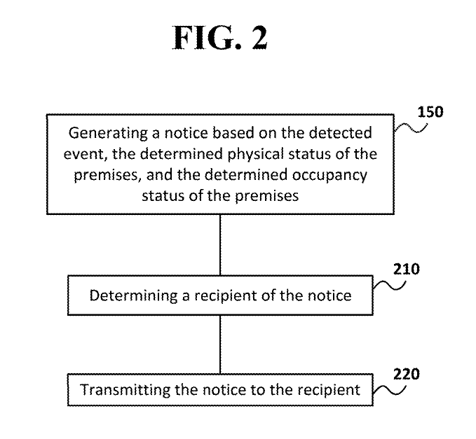

An occupancy status of the premises can include indications of whether the premises is presently occupied, the locations of the occupants, and if unoccupied, when the occupants are expected to return. Occupancy status is discussed in further detail below. FIG. 1 depicts, in an implementation, a method for determining a physical and occupancy status of a premises, collecting sensor data relating to the premises and/or an occupant, detecting an event based on the collected sensor data, and generating a notice based upon the detected event and the determined physical and occupancy statuses of the premises. Differences among detected events, the determined physical status, and occupancy status of the premises can generate different forms of notices in accordance with implementations of the disclosed subject matter. In an embodiment, the method also includes determining a recipient of the notice and transmitting 170 the notice to the recipient as shown in FIG. 2.

At 110, a physical status of a premises may be determined, such as by accessing a data table having one or more fields containing indicators related to components of the home. For example the data table may contain indicators for the open/close state and locked/unlocked state of doors and windows, whether an alarm system is activated, whether household appliances and electronics are activated, such as a refrigerator, oven, and television, a physical attribute such as a temperature, humidity, motion, magnetic field strength and orientation, etc., and identifiers and/or locations that can correspond to the sensors that detect such physical attributes. The physical status of the premises may be accessed, stored, and communicated through any network, data storage, and/or computing device used by a smart-home system. The information that serves as a basis for the physical status indicators may be provided by sensors and other data sources accessible by suitable network, data storage, and computing devices discussed in this disclosure. Sources of data of the indicators that make up the status of the premises may include the sensors and other data sources that make up the smart-home environment discussed in detail in later portions of this disclosure. Other data sources may include data accessible through an account with a public utility, such as a power company to determine the usage and availability of power supplied to the home, a telecommunications service provider, emergency medical services (EMS) provider, or an online government database. It should be noted that specific indicators used to determine a physical status may be manually selected by a user or be automatically selected by the smart-home system.

At 120, an occupancy status of a premises may be determined. An occupant can include a person or animal that permanently or temporarily resides at the premises. A person or animal need not be currently occupying the premises in order to be an occupant. For example a person who normally lives in a home but is presently on vacation outside of the home is an occupant of that premises whether or not she is presently on vacation. A pet, such as a family dog may be an occupant of a premises. Multiple people or animals may be occupants of a premises at a given time.

An occupancy status can be represented as an indicator of a mode in which the home is being used. Examples of such indicators include: a “stay” indicator, a “home” indicator, an “away” indicator, and a “vacation” indicator. The “home” indicator may represent a normal at-home mode where one or more occupants are present and moving about the premises in a fairly unrestricted way, such as a family at home during a weekend. For example, the parents may run errands such as shopping, doing yard work, and going to a restaurant. The children may be moved back and forth to sports practice or to friends' houses. The “away” indicator may represent a mode where all of the occupants are not in the home for a relatively short period of time, such as when the parents are at work and all of the children are at school during a weekday. For example, during a weekday, the parents may both be at work from 8 am-6 pm and the children may be at school and then at an after school program from 7 am-6 pm. Therefore during the 8 am-6 pm time period all occupants are not in the premises and the occupancy status (occupancy mode) of the home may be away. As another example, the “vacation” indicator may represent a mode where all of the occupants are away from the home for an extended period of time. For example, during the summer the entire family may travel to a beach 200 miles away and stay for a week. Finally, a “stay” indicator may relate to a mode where some or all of the occupants are in the home, but engaged in a particular activity that justifies a heightened security configuration for part of the residence and a more relaxed security configuration for other parts. For example, while the family sleeps, the exterior doors may be set in a closed and locked state such that a notice is generated if this state changes, whereas interior doors may be set in an open and unlocked state or left un-monitored. The “stay,” “away,” “home,” and “vacation” indicators may be selected manually by an occupant or, as discussed further below, determined automatically based on contextual information or other data sources related to the occupants.

Occupancy status modes such as “stay,” “away,” “home,” and “vacation” may be supplemented by occupancy information that relates to one or more particular occupants. For example, while the occupancy mode may be “away,” the system may receive information relating to the present location of the occupant. Such information can be derived from the occupant's smartphone of other sensors, such as in the occupant's car. Such supplemental information can affect the notice that may be generated by the system. For example, if the administrative users (e.g., both parents) of a smart-home system are known to be away from the home based on their sensed geolocations and if the present occupants are only the children, the system may generate an alarm to the fire department or a call to a parent's smartphone in the foregoing scenario involving the cooktop, even though the premises' occupancy status is in a home mode. If the parents are home, on the other hand, no notice may be generated by the system.

The determination of an occupancy status may be based on information from sensors and other data sources accessible by suitable network, data storage, and computing devices, such as those discussed in this disclosure. Sources of data of the indicators that make up the status of the occupants may include contextual information as described herein and information manually selected by an occupant. For example, determining a status of an occupant may include accessing a data table having one or more fields containing indicators related to the occupants of the premises. The status of the occupants may be selected by an occupant or automatically detected such as by access to contextual information related to the occupant. For example, the geolocation feature of an occupant's mobile device may be accessed to determine location. With the occupant's permission, calendar, email and/or social network information for the occupant may be accessed indicating the occupant is on vacation.

In an implementation, occupancy status can be determined based on the comings and goings of various occupants during the work week, which can be detected using various sensors such as motion sensors, geolocation sensors, lock and door sensors, etc. The data may demonstrate a repeated pattern useful for determining occupancy status. For example, a child may leave for school at 7:00 am, a parent may leave for work at 8:00 am and the other parent may leave for work at 8:45 am. The child may return to the home at 3:00 pm, and both parents may return at 6:00 pm. The family may retire for the evening at 10:00 pm. This pattern may be detected by monitoring contextual information or sensor data and may be used by the smart-home system to set an occupancy mode automatically. For example, occupancy status (mode) may be set to “stay” before 7:00 am, then switch to “away” until 6:00 pm when it switches to “home,” and the back to “stay” at 10:00 pm when the occupants go to sleep. Alternatively, a range of statuses may be suggested to the occupant and a particular status selected.

At 130, the system may collect sensor data to identify an event related to the premises. Data can include any information generated by a sensor. A sensor may include any device that can obtain information about the environment or an object with which the sensor is associated. Sensors may be described by the type of information they collect. For example, sensor types as disclosed herein may include motion, smoke, carbon monoxide, proximity, temperature, humidity, time, physical orientation, acceleration, location, entry, presence, pressure, light, sound, images, video and the like. A sensor also may be described in terms of the particular physical device that obtains the environmental information. For example, an accelerometer may obtain acceleration information, and thus may be used as a general motion sensor and/or an acceleration sensor. A sensor also may be described in terms of the specific hardware components used to implement the sensor. For example, a temperature sensor may include a thermistor, thermocouple, resistance temperature detector, integrated circuit temperature detector, or combinations thereof. A sensor also may be described in terms of a function or functions the sensor performs within an integrated sensor network, such as a smart-home environment as disclosed herein. For example, a sensor may operate as a security sensor when it is used to determine security events such as unauthorized entry. A sensor may operate with different functions at different times, such as where a motion sensor is used to control lighting in a smart-home environment when an authorized user is present, and is used to alert to unauthorized or unexpected movement when no authorized user is present, or when an alarm system is in an “armed” state, or the like. In some cases, a sensor may operate as multiple sensor types sequentially or concurrently, such as where a temperature sensor is used to detect a change in temperature, as well as the presence of a person or animal. A sensor also may operate in different modes at the same or different times. For example, a sensor may be configured to operate in one mode during the day and another mode at night. As another example, a sensor may operate in different modes based upon a state of a smart-home environment, or as otherwise directed by such a system. Sensors serving as a basis for collecting sensor data include the sensors and other data sources that make up the “smart-home environment.” Sensors are more thoroughly discussed in latter portions of this disclosure.

Collecting sensor data may be performed in accordance with the sensors, network, data storage, and computing devices discussed in this disclosure. For example the residence may contain a garage door, rear window, and one or more networked sensors, including a smart gas line sensor, and a plurality of smart motion sensors throughout the lawn surrounding the main residence structure. The motion sensors may indicate motion in front of the garage and along the driveway. The gas line sensor may indicate positive natural gas flow. Sensors may indicate phenomena of significance through various methodologies such as through comparison to historical averages for specific sensor locations or occupant-selected thresholds. The data from sensors may be collected by way of transmission through a network to a data storage medium in communication with a computing device, such as those described herein.

At 140, an event may be detected based on the collected sensor data. An event can include any phenomenon that is detectable, at least in part, by a sensor. Examples of events may include hazardous events usually warranting an emergency response, such as intrusion, earthquake, structural building failure, fire, poisonous gas leak, flood, wind intensive storm such as a tornado or hurricane, or sounds or images indicating violence or distress of an occupant. For example, a smoke detector sensor may detect smoke at a particular threshold concentration and a temperature sensor may measure temperature at particular threshold level. Thus, a system as disclosed herein may be configured to detect a fire event when both the smoke threshold and temperature thresholds are reached. A person of skill in the art will recognize the full range of sensor combinations suitable for detecting events.

Detecting an event may be based upon both the collected sensor data and the determined physical and occupancy status of the premises. For example, the occupancy status of a premises may include vacation mode, a physical status of the premises may include a normal room temperature reading in the living room and a natural gas flow sensor may detect a positive change in the rate of natural gas flow in an indoor portion of a gas line that runs to the furnace. The system may determine that a gas leak event is occurring based on the foregoing and generate a notice to the utility company and to the fire department. If, on the other hand, the physical status includes a low temperature reading in the living room (e.g., below a threshold such as 60 degrees Fahrenheit), then the system may determine that a normal heating event is occurring and generate no notice. If, in another example, the occupancy status includes a home mode and at least one occupant is detected within the home, and if the physical status includes a detected concentration of natural gas in the air above a threshold, then an audible alarm may be generated by the system within the house, even if the physical status includes a low temperature reading for the living room. Further, notices may be sent to the utility and fire department. In this and similar ways, different occupancy and physical statuses of a premises may change the response of the smart-home system to the same event determined by the system based on the same sensor data.

At 150, a notice may be generated based on the determined occupancy and physical status of the premises and a determined event. A notice can include any transmission that communicates with, or establishes the ability to communicate with, a person or entity. A notice may take various forms such as a data carrying signal, an audible alarm, a visual alarm, a text or image instruction, a tactile alarm, a camera feed, or an audio feed. For example a notice may be an emergency response such as a data signal alert to the fire department that there are indications of a fire in the premises, a verbal communication from an occupant away from the premises to a person within the premises instructing her to turn off the water line, or the activation of an guide voice and/or lights directing a user to an exit from a building. Further examples of a notice will be discussed in later portions of this disclosure.

For example, a smart-home system may receive data indicating elevated levels of carbon monoxide in the house. The system can determine that the physical status of the home includes no elevated temperatures that would be expected in the event of a fire, and that the furnace is on. If the occupancy status is determined to be a home mode, then a general alarm may be sounded throughout the home, which can include audible instructions to evacuate the home immediately. If the occupancy status is determined to be a stay mode (e.g., at night), then alarms can be activated in bedrooms. In particular, “bed thumping” alarms may be activated in the occupied beds, which shake the occupant of a bed in a manner that may be more effective for occupants susceptible to sleeping through alarms. If the occupancy status is determined to be away mode, then a text message or phone call can be generated and sent to one or more the occupants who are away from the home. This notice can include information such as the cause for the alarm (elevated concentrations of carbon monoxide) and include a link that, if selected by the recipient, automatically sends an emergency message to the fire department or places a call from the recipient's smartphone to the fire department. If the occupancy status is determined to be in vacation mode, a notice may automatically be sent to the fire department, along with a notice to a vacationing occupant that carbon monoxide has been detected and the fire department has been contacted. Also, a notice may be changed based on the time of day at which the event occurs or is determined to have occurred. For example, if the time of day is evening then exit light indicators notices may be generated and sent, causing lights to activate around viable exits from the home. The lights can help guide at-home occupants out of the premises when they are suffering from confusion and vertigo-like symptoms due to carbon monoxide poisoning.

FIG. 2 depicts an example of determining a recipient of the notice and transmitting the notice to the recipient as disclosed herein. The determination of a recipient of the notice may be based upon the determined physical and/or occupancy status of the premises, sensor data, the determined event and/or a profile of the occupant that can be created by the occupant or generated automatically, with the user's permission. Examples of recipients of a notice may include an emergency response organization, a police organization, a private security organization, a military organization, a personal contact of the occupant, a person located on the premises, a person located within a selected distance of the premises, and any device associated or in communication with any of the foregoing.

A profile may include a set of one or more personal or organizational contacts of the occupant and preferences and thresholds that relate to circumstances under which a contact or set of contacts should be contacted. For example, the profile may indicate a preference to be contacted first before contacting any emergency response authority, such as a police department or fire department. Contact data may include information that relates to the identity of the contact as well as address data that can be used to enable communication with the contact. For example an occupant's profile may include neighbors to notify in case an emergency or other event is detected, as well as emergency services organizations, such as police, fire and ambulance contacts. Communication information may be associated with each contact, such as a phone number, email address, and social network identifiers, data address, URL, network identifier, or similar contact address. A profile may include a set of conditions, types of notices, or other criteria under which a particular notice or type of notice should be sent to a particular recipient. Such information may be stored, for example, as a lookup table, a set of rules, or other selection forms as are known in the art. Default entries may be created in a profile, which then may be accepted, modified, or disabled by a user. Continuing the example, a default profile may indicate that a neighbor should be notified in case of a detected emergency such as an unauthorized or forced entry by an unknown person into the premises. Upon installing the system or at any time thereafter, a user may be presented with an interface that allows the user to enter an appropriate neighbor's contact information, or to modify the profile to only notify an emergency services organization. More generally, for any notice disclosed herein, a user may be provided the opportunity via an appropriate interface to modify any information stored in a profile, including any recipient or recipient type for any notice or type of notice disclosed herein, such as to update local emergency numbers, neighbor contact information, types of notices to send or refrain from sending, particular sensor data to omit from consideration when determining whether to send a notice, or the like. Such an interface may be provided via a connected device as disclosed herein, including smart-home devices, wearable devices, smartphones, tablets, computers, and the like.

At 210, a recipient of a notice may be determined based on the physical and occupancy status of the premises, sensor data and/or a determined event. For example, if the system determines that the garage door has been left open for more than a threshold amount of time and the occupancy status is determined to be home mode, a notice may be generated and sent to the user located in the home. If in away mode, a notice may be generated and sent to a neighbor, asking the neighbor to close the garage door.

At 220, the notice may be transmitted to the recipient. Transmission of a notice to a recipient may be conducted via a data network in communication with data storage and computing devices on which the subject matter of this disclosure are implemented. A person of ordinary skill in the art will recognize the full range of transmission techniques suitable for the subject matter of this disclosure.

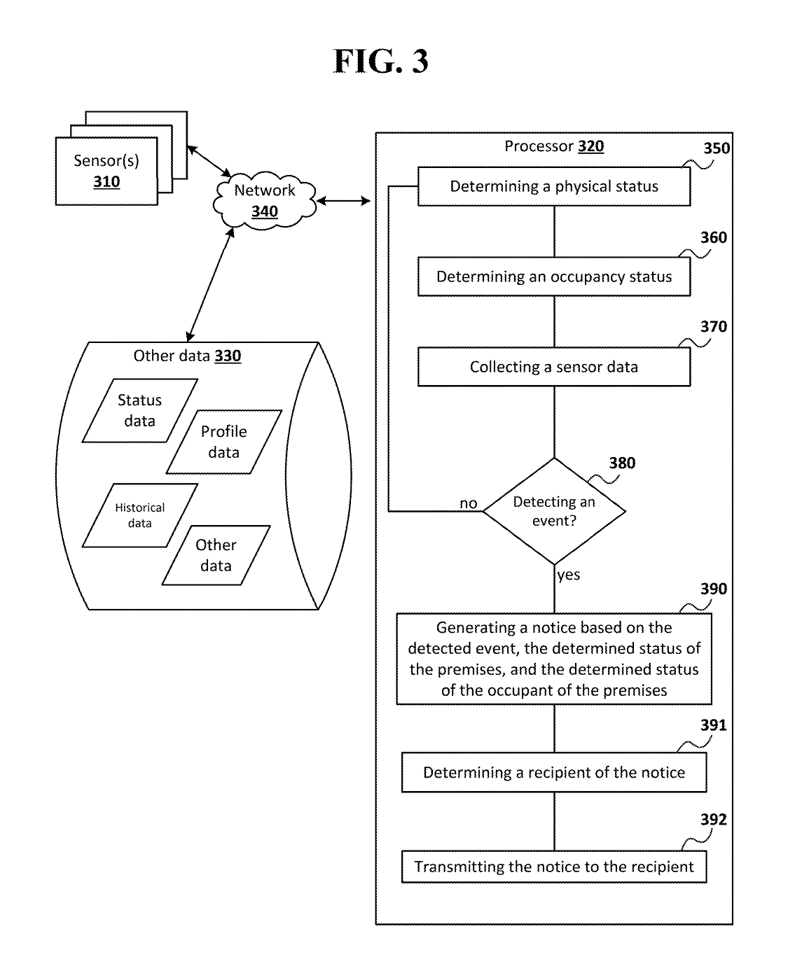

FIG. 3 shows an implementation of a system comprising at least on sensor 310, a processor 320, and other data on data storage 330 in communication with the at least one sensor via network 340, and an example method for generating a notice as disclosed herein. The processor is adapted and configured to determine a physical status of a premises at 350, determine an occupancy status of the premises at 360, collect sensor data at 370, detect an event at 380 based on the collected sensor data, and generate a notice based upon the detected event, the determined physical status of the premises, and the determined occupancy status of the premises at 390. As previously described, if an event is detected at 380, the processor may generate the notice and send the notice to an identified recipient. If no event is detected, the processor may continue to monitor the status of the premises, occupants, and/or sensors at 350-370. A recipient of the notice may be determined at 391, and transmitted to the recipient at 392. The instructions 350-392 may be executed by the processor in accordance with the method discussed regarding FIGS. 1-2 above. That is, the processor 320 may perform the method shown in FIG. 3 using similar or identical steps and techniques as previously described with respect to FIGS. 1-2. The system may be implemented on sensors, processors, data storage, and network components in accordance with the implementations discussed below and throughout this disclosure, as well as any additional components that a person of ordinary skill in the art would recognize as suitable for the purposes of this disclosure.

Historical data, such as a historical status of a premises, historical status of an occupant, and historical collected sensor data, may be used as a basis for further decision-making of the methods and systems disclosed herein. For example successful event-detection and notice generation circumstances may be used to improve confidence levels used to predict similar circumstances in the future. This data may be accessed in a similar manner to the status of a premises and status of an occupant referenced above.

In general, a “sensor” as disclosed herein may include multiple sensors or sub-sensors, such as where a position sensor includes both a global positioning sensor (GPS) as well as a wireless network sensor, which provides data that can be correlated with known wireless networks to obtain location information. Multiple sensors may be arranged in a single physical housing, such as where a single device includes movement, temperature, magnetic, and/or other sensors. Such a housing also may be referred to as a sensor or a sensor device. For clarity, sensors are described with respect to the particular functions they perform and/or the particular physical hardware used, when such specification is necessary for understanding of the embodiments disclosed herein.

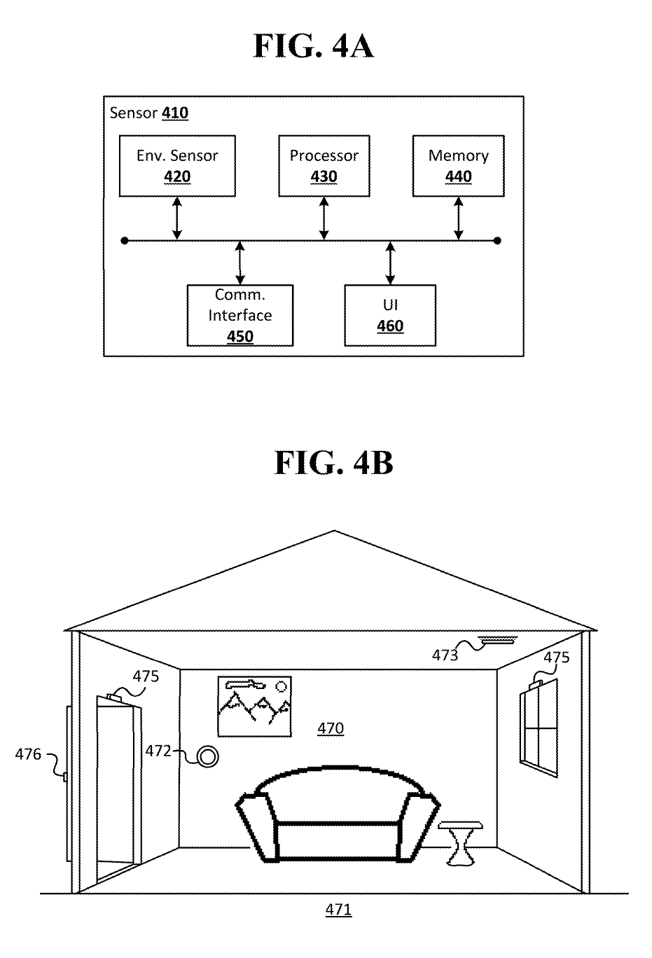

A sensor may include hardware in addition to the specific physical sensor that obtains information about the environment. FIG. 4A shows an example sensor as disclosed herein. The sensor 410 may include an environmental sensor 420, such as a temperature sensor, smoke sensor, carbon monoxide sensor, motion sensor, accelerometer, proximity sensor, passive infrared (PIR) sensor, magnetic field sensor, radio frequency (RF) sensor, light sensor, humidity sensor, pressure sensor, microphone, or any other suitable environmental sensor, that obtains a corresponding type of information about the environment in which the sensor 410 is located. A processor 430 may receive and analyze data obtained by the sensor 410, control operation of other components of the sensor 410, and process communication between the sensor and other devices. The processor 430 may execute instructions stored on a computer-readable memory 440. The memory 440 or another memory in the sensor 410 may also store environmental data obtained by the sensor 410. A communication interface 450, such as a Wi-Fi or other wireless interface, Ethernet or other local network interface, or the like may allow for communication by the sensor 410 with other devices. A user interface (UI) 460 may provide information and/or receive input from a user of the sensor. The UI 460 may include, for example, a speaker to output an audible alarm when an event is detected by the sensor 460. Alternatively, or in addition, the UI 460 may include a light to be activated when an event is detected by the sensor 410. The user interface may be relatively minimal, such as a liquid crystal display (LCD), light-emitting diode (LED) display, or limited-output display, or it may be a full-featured interface such as a touchscreen. Components within the sensor 410 may transmit and receive information to and from one another via an internal bus or other mechanism as will be readily understood by one of skill in the art. One or more components may be implemented in a single physical arrangement, such as where multiple components are implemented on a single integrated circuit. Sensors as disclosed herein may include other components, and/or may not include all of the illustrative components shown.

As an example of the implementation of sensors within a premises FIG. 4B depicts, one or more sensors implemented in a home premises 470 as part of a “smart-home environment”. Smart-home environment 471 may include multiple types of premises management devices, such as one or more intelligent, multi-sensing, network-connected thermostats 472, one or more intelligent, multi-sensing, network-connected poisonous gas detection units 473, one or more intelligent, multi-sensing, network-connected entry detection units 475, and one or more network-connected door handles 476.

In some configurations, two or more sensors may generate data that can be used by a processor of a system to generate a response and/or infer a state of the environment. For example, an ambient light sensor in a room may determine that the room is dark (e.g., less than 60 lux). A microphone in the room may detect a sound above a set threshold, such as 60 dB. The system processor may determine, based on the data generated by both sensors, that it should activate one or more lights in the room. In the event the processor only received data from the ambient light sensor, the system may not have any basis to alter the state of the lighting in the room. Similarly, if the processor only received data from the microphone, the system may lack sufficient data to determine whether activating the lights in the room is necessary, for example, during the day the room may already be bright or during the night the lights may already be on. As another example, two or more sensors may communicate with one another. Thus, data generated by multiple sensors simultaneously or nearly simultaneously may be used to determine a state of an environment and, based on the determined state, generate a response.

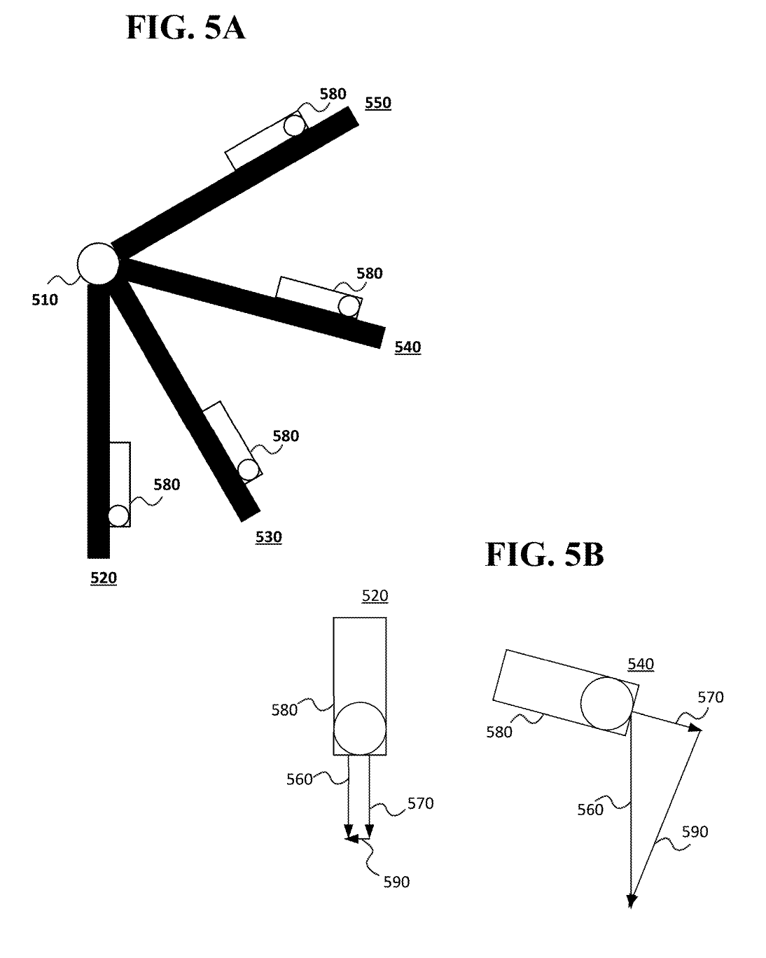

As another example, a system may employ a magnetometer affixed to a door jamb and a magnet affixed to the door. When the door is closed, the magnetometer may detect the magnetic field emanating from the magnet. If the door is opened, the increased distance may cause the magnetic field near the magnetometer to be too weak to be detected by the magnetometer. If the system is activated, it may interpret such non-detection as the door being ajar or open. In some configurations, a separate sensor or a sensor integrated into one or more of the magnetometer and/or magnet may be incorporated to provide data regarding the status of the door. For example, an accelerometer and/or a compass may be affixed to the door and indicate the status of the door and/or augment the data provided by the magnetometer. FIG. 5A shows a schematic representation of an example of a door that opens by a hinge mechanism 510. In the first position 520, the door is closed and the compass 580 may indicate a first direction. The door may be opened at a variety of positions as shown 530, 540, and 550. The fourth position 550 may represent the maximum amount the door can be opened. Based on the compass 580 readings, the position of the door may be determined and/or distinguished more specifically than merely open or closed. In the second position 530, for example, the door may not be far enough apart for a person to enter the home. A compass or similar sensor may be used in conjunction with a magnet, such as to more precisely determine a distance from the magnet, or it may be used alone and provide environmental information based on the ambient magnetic field, as with a conventional compass.

FIG. 5B shows a compass 580 in two different positions, 520 and 540, from FIG. 5A. In the first position 520, the compass detects a first direction 560. The compass's direction is indicated as 570 and it may be a known distance from a particular location. For example, when affixed to a door, the compass may automatically determine the distance from the door jamb or a user may input a distance from the door jamb. The distance representing how far away from the door jamb the door is 560 may be computed by a variety of trigonometric formulas. In the first position 520, the door is indicated as not being separate from the door jamb (i.e., closed) 5b0. Although features 560 and 570 are shown as distinct in FIG. 5B, they may overlap entirely. In the second position 540, the distance between the door jamb and the door 590 may indicate that the door has been opened wide enough that a person may enter. Thus, the sensors may be integrated into a home system, mesh network, or work in combination with other sensors positioned in and/or around an environment.

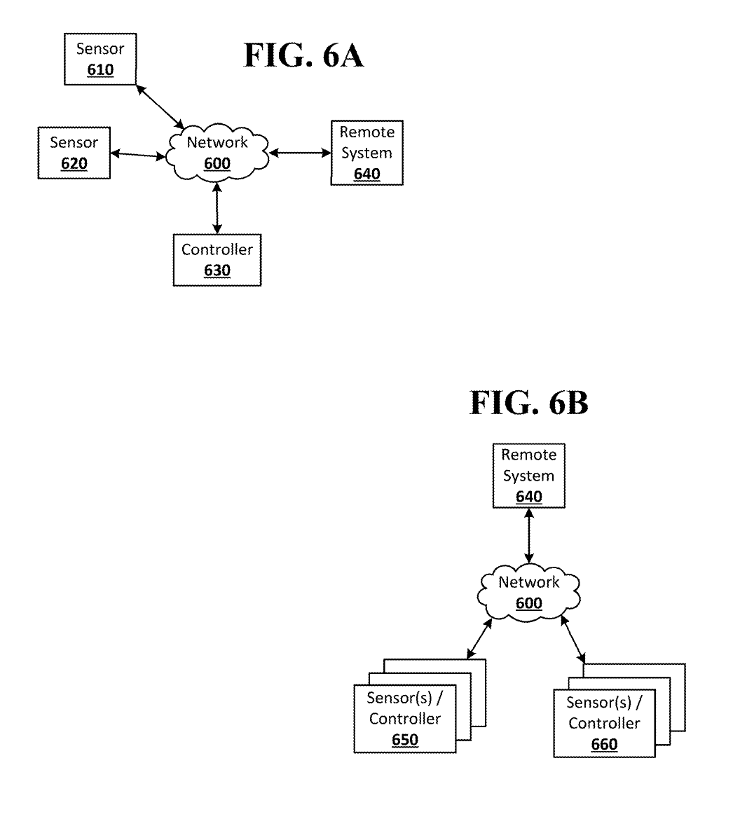

In some configurations, an accelerometer may be employed to indicate how quickly the door is moving. For example, the door may be lightly moving due to a breeze. This may be contrasted with a rapid movement due to a person swinging the door open. The data generated by the compass, accelerometer, and/or magnetometer may be analyzed and/or provided to a central system such as a controller 630 and/or remote system 640 depicted in FIG. 6A. The data may be analyzed to learn a user behavior, an environment state, and/or as a component of a smart-home system. While the above example is described in the context of a door, a person having ordinary skill in the art will appreciate the applicability of the disclosed subject matter to other implementations such as a window, garage door, fireplace doors, vehicle windows/doors, faucet positions (e.g., an outdoor spigot), a gate, seating position, other openings, etc.

As previously described, the data collected from one or more sensors may be used to determine the physical status and/or occupancy status of a premises. For example, door sensors as described with respect to FIGS. 5A and 5B may be used to determine that an unknown person has entered the premises. The system may first determine that a person has entered the premises due to sensors detecting a door opening and closing in a time span previously determined to be consistent with a person entering or leaving the premises. The system next may identify the person as “unknown” due to the absence of a smartphone, key fob, wearable device, or other device typically used to identify occupants of the premises. Continuing the example, sensor data may be received indicating that a valuable item within the premises has been moved, or that a component of the smart-home environment associated with security functions such as a controller disclosed herein, has been moved or damaged. Such sensor data may be received, for example, from a sensor attached to or otherwise associated with the valuable item, from the smart-home component itself, or from one or more other sensors within the smart-home environment. In response, the system may generate an alert indicating that an unknown person has entered the premises and/or that the item or component has been moved or damaged. The system may further determine that an occupant of the home is close by but not present in the premises, for example based upon a Wi-Fi signal received from the occupant's smartphone, but an absence of near-field or other short-range communication from the same smartphone. In this case, the system may be configured to send the alert to the occupant's smartphone, such as via SMS, email, or other communication. As another example, the system may determine that the premises is already in an “away” state and that no occupants are nearby or expected to return in the near future. In this case, the system may be configured to send the alert to a local law enforcement agency, such as via email, SMS, recorded phone call, or the like.

Data generated by one or more sensors may indicate patterns in the behavior of one or more users and/or an environment state over time, and thus may be used to “learn” such characteristics. For example, data generated by an ambient light sensor in a room of a house and the time of day may be stored in a local or remote storage medium with the permission of an end user. A processor in communication with the storage medium may compute a behavior based on the data generated by the light sensor. The light sensor data may indicate that the amount of light detected increases until an approximate time or time period, such as 3:30 pm, and then declines until another approximate time or time period, such as 5:30 pm, at which point there is an abrupt increase in the amount of light detected. In many cases, the amount of light detected after the second time period may be either below a dark level of light (e.g., under or equal to 60 lux) or bright (e.g., equal to or above 400 lux). In this example, the data may indicate that after 5:30 pm, an occupant is turning on/off a light as the occupant of the room in which the sensor is located enters/leaves the room. At other times, the light sensor data may indicate that no lights are turned on/off in the room. The system, therefore, may learn occupants' patterns of turning on and off lights, and may generate a response to the learned behavior. For example, at 5:30 pm, a smart-home environment or other sensor network may automatically activate the lights in the room if it detects an occupant in proximity to the home. In some embodiments, such behavior patterns may be verified using other sensors. Continuing the example, user behavior regarding specific lights may be verified and/or further refined based upon states of, or data gathered by, smart switches, outlets, lamps, and the like.

Such learning behavior may be implemented in accordance with the techniques disclosed herein. For example, a smart-home environment as disclosed herein may be configured to learn appropriate notices to generate or other actions to take in response to a determination that a notice should be generated, and/or appropriate recipients of a particular notice or type of notice. As a specific example, a smart-home environment may determine that after a notice has been sent to a first occupant of the smart-home premises indicating that a window in a room has been left open, a second occupant is always detected in the room within a threshold time period, and the window is closed shortly thereafter. After making such a determination, in future occurrences the notice may be sent to the second occupant or to both occupants for the purposes of improving the efficacy of the notice. In an embodiment, such “learned” behaviors may be reviewed, overridden, modified, or the like by a user of the system, such as via a computer-provided interface to a smart-home environment as disclosed herein.

Sensors as disclosed herein may operate within a communication network, such as a conventional wireless network, and/or a sensor-specific network through which sensors may communicate with one another and/or with dedicated other devices. In some configurations one or more sensors may provide information to one or more other sensors, to a central controller, or to any other device capable of communicating on a network with the one or more sensors. A central controller may be general- or special-purpose. For example, one type of central controller is a home automation network that collects and analyzes data from one or more sensors within the home. Another example of a central controller is a special-purpose controller that is dedicated to a subset of functions, such as a security controller that collects and analyzes sensor data primarily or exclusively as it relates to various security considerations for a location. A central controller may be located locally with respect to the sensors with which it communicates and from which it obtains sensor data, such as in the case where it is positioned within a home that includes a home automation and/or sensor network. Alternatively or in addition, a central controller as disclosed herein may be remote from the sensors, such as where the central controller is implemented as a cloud-based system that communicates with multiple sensors, which may be located at multiple locations and may be local or remote with respect to one another.

FIG. 6A shows an example of a sensor network as disclosed herein, which may be implemented over any suitable wired and/or wireless communication networks. One or more sensors 610 and 620 may communicate via a local network 600, such as a Wi-Fi or other suitable network, with each other and/or with a controller 630. The controller may be a general- or special-purpose computer. The controller may, for example, receive, aggregate, and/or analyze environmental information received from the sensors 610 and 620. The sensors 610 and 620 and the controller 630 may be located locally to one another, such as within a single dwelling, office space, building, room, or the like, or they may be remote from each other, such as where the controller 630 is implemented in a remote system 640 such as a cloud-based reporting and/or analysis system. Alternatively or in addition, sensors may communicate directly with a remote system 640. The remote system 640 may, for example, aggregate data from multiple locations, provide instruction, software updates, and/or aggregated data to a controller 630 and/or sensors 610, 620.

The devices of the disclosed subject matter may be communicatively connected via the network 600, which may be a mesh-type network such as Thread, which provides network architecture and/or protocols for devices to communicate with one another. Typical home networks may have a single device point of communications. Such networks may be prone to failure, such that devices of the network cannot communicate with one another when the single device point does not operate normally. The mesh-type network of Thread, which may be used in methods and systems of the disclosed subject matter may avoid communication using a single device. That is, in the mesh-type network, such as network 600, there is no single point of communication that may fail so as to prohibit devices coupled to the network from communicating with one another.

The communication and network protocols used by the devices communicatively coupled to the network 600 may provide secure communications, minimize the amount of power used (i.e., be power efficient), and support a wide variety of devices and/or products in a home, such as appliances, access control, climate control, energy management, lighting, safety, and security. For example, the protocols supported by the network and the devices connected thereto may have an open protocol which may carry IPv6 natively.

The Thread network, such as network 600, may be easy to set up and secure to use. The network 600 may use an authentication scheme, such as AES (Advanced Encryption Standard) encryption or the like, to reduce and/or minimize security holes that exist in other wireless protocols. The Thread network may be scalable to connect devices (e.g., 2, 5, 10, 20, 50, 100, 150, 200, or more devices) into a single network supporting multiple hops (e.g., so as to provide communications between devices when one or more nodes of the network is not operating normally). The network 600, which may be a Thread network, may provide security at the network and application layers. One or more devices communicatively coupled to the network 600 (e.g., controller 630, remote system 640, and the like) may store product install codes to ensure only authorized devices can join the network 600. One or more operations and communications of network 600 may use cryptography, such as public-key cryptography.

The devices communicatively coupled to the network 600 of the smart-home environment disclosed herein may have low power consumption and/or reduced power consumption. That is, devices efficiently communicate to with one another and operate to provide functionality to the user, where the devices may have reduced battery size and increased battery lifetimes over conventional devices. The devices may include sleep modes to increase battery life and reduce power requirements. For example, communications between devices coupled to the network 600 may use the power-efficient IEEE 802.15.4 MAC/PHY protocol. In embodiments of the disclosed subject matter, short messaging between devices on the network 600 may conserve bandwidth and power. The routing protocol of the network 600 may reduce network overhead and latency. The communication interfaces of the devices coupled to the smart-home environment may include wireless system-on-chips to support the low-power, secure, stable, and/or scalable communications network 600.

The sensor network shown in FIG. 6A may be an example of a smart-home environment. The depicted smart-home environment may include a structure, a house, office building, garage, mobile home, or the like. The devices of the smart-home environment, such as the sensors 610 and 620 the controller 630, and the network 600 may be integrated into a smart-home environment that does not include an entire structure, such as an apartment, condominium, or office space.

The smart-home environment can control and/or be coupled to devices outside of the structure. For example, one or more of the sensors 610 and 620 may be located outside the structure, for example, at one or more distances from the structure (e.g., sensors 610 and 620 may be disposed outside the structure, at points along a land perimeter on which the structure is located, and the like. One or more of the devices in the smart-home environment need not physically be within the structure. For example, the controller 630 which may receive input from the sensors 610 and 620 may be located outside of the structure.

The structure of the smart-home environment may include a plurality of rooms, separated at least partly from each other via walls. The walls can include interior walls or exterior walls. Each room can further include a floor and a ceiling. Devices of the smart-home environment, such as the sensors 610 and 620, may be mounted on, integrated with and/or supported by a wall, floor, or ceiling of the structure.

The smart-home environment including the sensor network shown in FIG. 6A may include a plurality of devices, including intelligent, multi-sensing, network-connected devices, that can integrate seamlessly with each other and/or with a central server or a cloud-computing system (e.g., controller 630 and/or remote system 640) to provide home-security and smart-home features. The smart-home environment may include one or more intelligent, multi-sensing, network-connected thermostats (e.g., “smart thermostats”), one or more intelligent, network-connected, multi-sensing hazard detection units (e.g., “smart hazard detectors”), and one or more intelligent, multi-sensing, network-connected entryway interface devices (e.g., “smart doorbells”). The smart hazard detectors, smart thermostats, and smart doorbells may be the sensors 610 and 620 shown in FIG. 6A.

For example, a smart thermostat may detect ambient climate characteristics (e.g., temperature and/or humidity) and may accordingly control an HVAC (heating, ventilating, and air conditioning) system of the structure. For example, the ambient climate characteristics may be detected by sensors 610 and 620 shown in FIG. 6A, and the controller 630 may control the HVAC system (not shown) of the structure.

As another example, a smart hazard detector may detect the presence of a hazardous substance or a substance indicative of a hazardous substance (e.g., smoke, fire, or carbon monoxide). For example, smoke, fire, and/or carbon monoxide may be detected by sensors 610 and 620 shown in FIG. 6A, and the controller 630 may control an alarm system to provide a visual and/or audible alarm to the user of the smart-home environment.

As another example, a smart doorbell may control doorbell functionality, detect a person's approach to or departure from a location (e.g., an outer door to the structure), and announce a person's approach or departure from the structure via audible and/or visual message that is output by a speaker and/or a display coupled to, for example, the controller 630.

In some embodiments, the smart-home environment of the sensor network shown in FIG. 6A may include one or more intelligent, multi-sensing, network-connected wall switches (e.g., “smart wall switches”), one or more intelligent, multi-sensing, network-connected wall plug interfaces (e.g., “smart wall plugs”). The smart wall switches and/or smart wall plugs may be or include one or more of the sensors 610 and 620 shown in FIG. 6A. A smart wall switch may detect ambient lighting conditions, and control a power and/or dim state of one or more lights. For example, a sensor such as sensors 610 and 620, may detect ambient lighting conditions, and a device such as the controller 630 may control the power to one or more lights (not shown) in the smart-home environment. Smart wall switches may also control a power state or speed of a fan, such as a ceiling fan. For example, sensors 610 and 620 may detect the power and/or speed of a fan, and the controller 630 may adjust the power and/or speed of the fan, accordingly. Smart wall plugs may control supply of power to one or more wall plugs (e.g., such that power is not supplied to the plug if nobody is detected to be within the smart-home environment). For example, one of the smart wall plugs may control supply of power to a lamp (not shown).

In embodiments of the disclosed subject matter, a smart-home environment may include one or more intelligent, multi-sensing, network-connected entry detectors (e.g., “smart entry detectors”). Such detectors may be or include one or more of the sensors 610 and 620 shown in FIG. 6A. The illustrated smart entry detectors (e.g., sensors 610 and 620) may be disposed at one or more windows, doors, and other entry points of the smart-home environment for detecting when a window, door, or other entry point is opened, broken, breached, and/or compromised. The smart entry detectors may generate a corresponding signal to be provided to the controller 630 and/or the remote system 640 when a window or door is opened, closed, breached, and/or compromised. In some embodiments of the disclosed subject matter, the alarm system, which may be included with controller 630 and/or coupled to the network 600 may not arm unless all smart entry detectors (e.g., sensors 610 and 620) indicate that all doors, windows, entryways, and the like are closed and/or that all smart entry detectors are armed.

The smart-home environment of the sensor network shown in FIG. 6A can include one or more intelligent, multi-sensing, network-connected doorknobs (e.g., “smart doorknob”). For example, the sensors 610 and 620 may be coupled to a doorknob of a door (e.g., doorknobs located on external doors of the structure of the smart-home environment). However, it should be appreciated that smart doorknobs can be provided on external and/or internal doors of the smart-home environment.

The smart thermostats, the smart hazard detectors, the smart doorbells, the smart wall switches, the smart wall plugs, the smart entry detectors, the smart doorknobs, the keypads, and other devices of a smart-home environment (e.g., as illustrated as sensors 610 and 620 of FIG. 6A) can be communicatively coupled to each other via the network 600, and to the controller 630 and/or remote system 640 to provide security, safety, and/or comfort for the smart-home environment. Alternatively or in addition, each of the devices of the smart-home environment may provide data that can be used to determine occupancy and/or physical status of a premises, as well as data that may be used to determine an appropriate recipient of a notification, as previously disclosed herein.

A user can interact with one or more of the network-connected smart devices (e.g., via the network 600). For example, a user can communicate with one or more of the network-connected smart devices using a computer (e.g., a desktop computer, laptop computer, tablet, or the like) or other portable electronic device (e.g., a smartphone, a tablet, a key FOB, or the like). A webpage or application can be configured to receive communications from the user and control the one or more of the network-connected smart devices based on the communications and/or to present information about the device's operation to the user. For example, the user can view, arm or disarm the security system of the home.

One or more users can control one or more of the network-connected smart devices in the smart-home environment using a network-connected computer or portable electronic device. In some examples, some or all of the users (e.g., individuals who live in the home) can register their mobile device and/or key FOBs with the smart-home environment (e.g., with the controller 630). Such registration can be made at a central server (e.g., the controller 630 and/or the remote system 640) to authenticate the user and/or the electronic device as being associated with the smart-home environment, and to provide permission to the user to use the electronic device to control the network-connected smart devices and systems of the smart-home environment. A user can use their registered electronic device to remotely control the network-connected smart devices and systems of the smart-home environment, such as when the occupant is at work or on vacation. The user may also use their registered electronic device to control the network-connected smart devices when the user is located inside the smart-home environment.

Alternatively, or in addition to registering electronic devices, the smart-home environment may make inferences about which individuals live in the home (occupants) and are therefore users and which electronic devices are associated with those individuals. As such, the smart-home environment may “learn” who is a user (e.g., an authorized user) and permit the electronic devices associated with those individuals to control the network-connected smart devices of the smart-home environment (e.g., devices communicatively coupled to the network 600), in some embodiments including sensors used by or within the smart-home environment. Various types of notices and other information may be provided to users via messages sent to one or more user electronic devices. For example, the messages can be sent via email, short message service (SMS), multimedia messaging service (MMS), unstructured supplementary service data (USSD), as well as any other type of messaging services and/or communication protocols. As previously described, such notices may be generated in response to specific determinations of the occupancy and/or physical status of a premises, or they may be sent for other reasons as disclosed herein.

A smart-home environment may include communication with devices outside of the smart-home environment but within a proximate geographical range of the home. For example, the smart-home environment may include an outdoor lighting system (not shown) that communicates information through the communication network 600 or directly to a central server or cloud-computing system (e.g., controller 630 and/or remote system 640) regarding detected movement and/or presence of people, animals, and any other objects and receives back commands for controlling the lighting accordingly.

The controller 630 and/or remote system 640 can control the outdoor lighting system based on information received from the other network-connected smart devices in the smart-home environment. For example, in the event that any of the network-connected smart devices, such as smart wall plugs located outdoors, detect movement at nighttime, the controller 630 and/or remote system 640 can activate the outdoor lighting system and/or other lights in the smart-home environment.

In some configurations, a remote system 640 may aggregate data from multiple locations, such as multiple buildings, multi-resident buildings, individual residences within a neighborhood, multiple neighborhoods, and the like. In general, multiple sensor/controller systems 650 and 660 as shown FIG. 6B may provide information to the remote system 640. The systems 650 and 660 may provide data directly from one or more sensors as previously described, or the data may be aggregated and/or analyzed by local controllers such as the controller 630, which then communicates with the remote system 640. The remote system may aggregate and analyze the data from multiple locations, and may provide aggregate results to each location. For example, the remote system 640 may examine larger regions for common sensor data or trends in sensor data, and provide information on the identified commonality or environmental data trends to each local system 650 and 660. Aggregated data may be used to generate appropriate notices and/or determine appropriate recipients for such notices as disclosed herein. For example, the remote system 640 may determine that the most common user response to a notification that a garage door has been left open while a security component of the smart-home environment is in an armed state, is that the user returns to the premises and closes the garage door. Individual smart-home systems and/or controllers as previously disclosed may receive such data from the remote system and, in response, set a default action of closing the garage door when the system determines that an armed state has been set and the garage door has been left open for more than a minimum threshold of time. The data provided to the individual systems may be only aggregate data, i.e., such that no individual information about any one other smart-home environment or type of smart-home environment is provided to any other. As another example, the remote system may receive data from multiple premises in a particular geographic region, indicating that it is raining in the region, and that the rain is moving east (based on the times at which the data indicating rainfall is received from different premises). In response, the remote system may provide an indication to premises further to the east that rain may be expected. In response, notifications may be provided to occupants of the individual premises that rain is expected, that particular windows should be closed, or the like. In some configurations users may be provided with the option of receiving such aggregated data, and/or with the option of providing anonymous data to a remote system for use in such aggregation. In some configurations, aggregated data also may be provided as “historical” data as previously disclosed. Such data may be used by a remote system and/or by individual smart-home environments to identify trends, predict physical statuses of a premises, and the like.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, specific information about a user's residence may be treated so that no personally identifiable information can be determined for the user, or a user's geographic location may be generalized where location information is obtained (such as to a city, ZIP code, or state level), so that a particular location of a user cannot be determined. As another example, systems disclosed herein may allow a user to restrict the information collected by those systems to applications specific to the user, such as by disabling or limiting the extent to which such information is aggregated or used in analysis with other information from other users. Thus, the user may have control over how information is collected about the user and used by a system as disclosed herein.

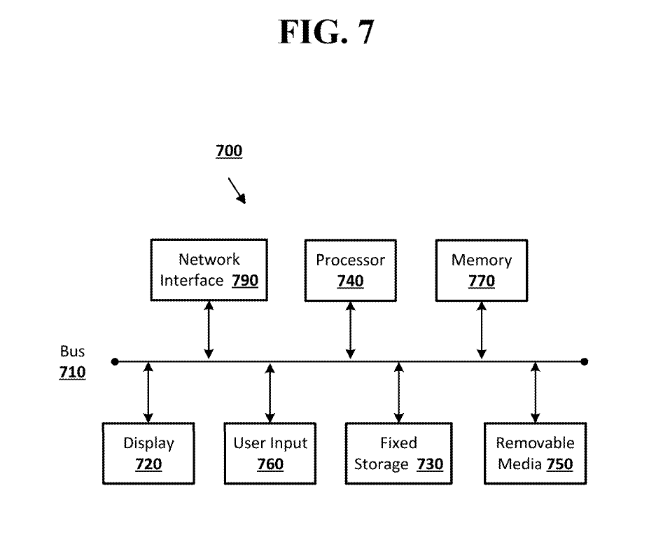

Embodiments of the presently disclosed subject matter may be implemented in and used with a variety of computing devices. FIG. 7 is an example of a computing device 700 suitable for implementing embodiments of the presently disclosed subject matter. For example, the device 700 may be used to implement a controller, a device including sensors as disclosed herein, or the like. Alternatively or in addition, the device 700 may be, for example, a desktop or laptop computer, or a mobile computing device such as a smart phone, tablet, or the like. The device 700 may include a bus 710 which interconnects major components of the computer 700, such as a central processor 740, a memory 770 such as Random Access Memory (RAM), Read Only Memory (ROM), flash RAM, or the like, a user display 720 such as a display screen, a user input interface 760, which may include one or more controllers and associated user input devices such as a keyboard, mouse, touch screen, and the like, a fixed storage 730 such as a hard drive, flash storage, and the like, a removable media component 750 operative to control and receive an optical disk, flash drive, and the like, and a network interface 790 operable to communicate with one or more remote devices via a suitable network connection.

The bus 710 allows data communication between the central processor 740 and one or more memory components 750 and 770, which may include RAM, ROM, and other memory, as previously noted. Applications resident with the computer 700 are generally stored on and accessed via a computer readable storage medium.

The fixed storage 730 may be integral with the computer 700 or may be separate and accessed through other interfaces. The network interface 790 may provide a direct connection to a remote server via a wired or wireless connection. The network interface 790 may provide such connection using any suitable technique and protocol as will be readily understood by one of skill in the art, including digital cellular telephone, Wi-Fi, Bluetooth(R), near-field, and the like. For example, the network interface 790 may allow the device to communicate with other computers via one or more local, wide-area, or other communication networks, as described in further detail herein.

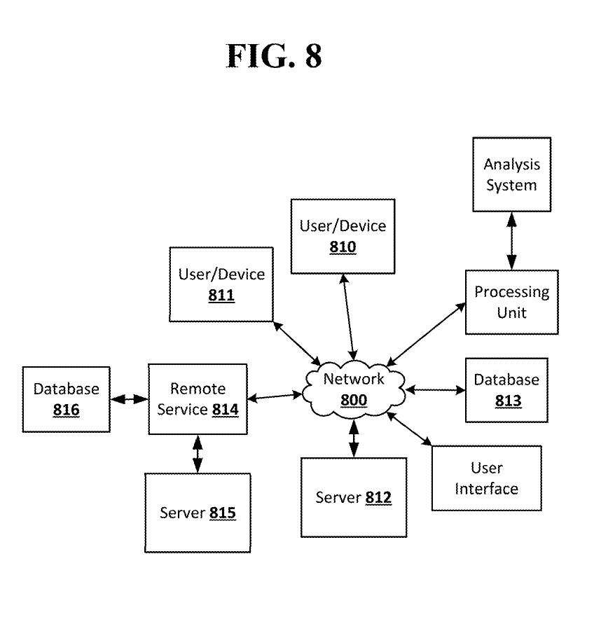

FIG. 8 shows an example network arrangement according to an embodiment of the disclosed subject matter. One or more devices 810 and 811, such as local computers, smart phones, tablet computing devices, and the like may connect to other devices via one or more networks 800. Each device may be a computing device as previously described. The network may be a local network, wide-area network, the Internet, or any other suitable communication network or networks, and may be implemented on any suitable platform including wired and/or wireless networks. The devices may communicate with one or more remote devices, such as servers 812 and/or databases 813. The remote devices may be directly accessible by the devices 810 and 811, or one or more other devices may provide intermediary access such as where a server 812 provides access to resources stored in a database 813. The devices 810 and 811 also may access remote platforms 814 or services provided by remote platforms 814 such as cloud computing arrangements and services. The remote platform 814 may include one or more servers 815 and/or databases 816.

Various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as hard drives, USB (universal serial bus) drives, or any other machine readable storage medium, such that when the computer program code is loaded into and executed by a computer, the computer becomes an apparatus for practicing embodiments of the disclosed subject matter. When implemented on a general-purpose microprocessor, the computer program code may configure the microprocessor to become a special-purpose device, such as by creation of specific logic circuits as specified by the instructions.

Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
determining a physical status of a premises;
determining an occupancy status of the premises;
collecting a sensor data about the premises;
determining an event based upon the collected sensor data; and
generating a notice based upon the detected event, the determined physical status of the premises, and the determined occupancy status of the premises.

2. The method of claim 1, further comprising determining a recipient of the notice.

3. The method of claim 1, further comprising determining a recipient of the notice based upon at least one of the group consisting of: the determined physical status of the premises, the determined occupancy status of the premises, the collected sensor data, the detected event, and a profile of an occupant of the premises.

4. The method of claim 1, further comprising determining a recipient of the notice based upon at least one of the group consisting of: the determined physical status of the premises, the determined occupancy status of the premises, the collected sensor data, the detected event, and a profile of an occupant of the premises; and
wherein the profile of the occupant comprises at least one of the group consisting of: a personal contact, an employer, a neighbor, a medical care provider, a community organization, and an educational organization.

5. The method of claim 1, further comprising determining a recipient of the notice, wherein the recipient is at least one of the group consisting of: an emergency response organization, a police organization, a private security organization, a military organization, a personal contact of an occupant of the premises, a person located on the premises, a person located within a selected distance of the premises.

6. The method of claim 1, further comprising transmitting the notice.

7. The method of claim 1, further comprising determining a recipient of the notice based upon at least one of the group consisting of: the determined physical status of the premises, the determined occupancy status of the premises, the collected sensor data, the detected event, and a profile of an occupant of the premises; and
transmitting the notice to the recipient.

8. The method of claim 1, further comprising determining a recipient of the notice based upon at least one of the group consisting of: the determined physical status of the premises, the determined occupancy status of the premises, the collected sensor data, the detected event, and a profile of an occupant of the premises;
wherein the profile of the occupant comprises at least one of the group consisting of: a personal contact, an employer, a neighbor, a medical care provider, a community organization, and an educational organization; and
transmitting the notice to the recipient.

9. The method of claim 1, wherein the status of the premises comprises at least one of the group consisting of: an open/close indicator, a lock/unlock indicator, a heating/cooling system indicator, an appliance indicator, a lighting indicator, a computer indicator, a network indicator, a power system indicator, a water system indicator, a gas system indicator, and a robotic device indicator.

10. The method of claim 1, wherein determining the physical status of the premises is based upon at least one of the group consisting of: a historical physical status of the premises, a historical sensor data of the premises, and a historical occupancy status of the premises.

11. A system comprising:
at least one sensor; and
a processor in communication with the at least one sensor and adapted and configured to: determine a physical status of a premises, determine an occupancy status of the premises, collect sensor data about the premises, detect an event based upon the collected sensor data, and generate a notice based upon the detected event, the determined physical status of the premises, and the determined occupancy status of the premises.

12. The system of claim 11, wherein the processor in communication with the at least one sensor is further adapted and configured to determine a recipient of the notice.

13. The system of claim 11, wherein the processor in communication with the at least one sensor is further adapted and configured to determine a recipient of the notice based upon at least one of the group consisting of: the determined physical status of the premises, the determined occupancy status of the premises, the collected sensor data, the detected event, and a profile of an occupant of the premises.

14. The system of claim 11, wherein the processor in communication with the at least one sensor is further adapted and configured to determine a recipient of the notice based upon at least one of the group consisting of: the determined physical status of the premises, the determined occupancy status of the premises, the collected sensor data, the detected event, and a profile of an occupant of the premises; and
wherein the profile of the occupant comprises at least one of the group consisting of: a personal contact, an employer, a neighbor, a medical care provider, a community organization, and an educational organization.

15. The system of claim 11, wherein the processor in communication with the at least one sensor is further adapted and configured to determine a recipient of the notice, wherein the recipient is at least one of the group consisting of: an emergency response organization, a police organization, a private security organization, a military organization, a personal contact of the occupant, a person located on the premises, and a person located within a selected distance of the premises.

16. A method comprising:
determining a physical status of a premises;
determining an occupancy status of the premises, based, at least in part, on data about an occupant located within the premises;
collecting sensor data about the premises;
detecting an event based upon the collected sensor data; and
generating a notice based upon the detected event, the determined physical status of the premises, and the determined occupancy status of the premises;
determining a recipient of the notice based upon at least one of the group consisting of: the determined physical status of the premises, the determined occupancy status of the premises, and a profile of an occupant of the premises; and
transmitting the notice to the recipient.

17. The method of claim 16, wherein the detected event is a hazardous event and the determined recipient is not emergency personnel, law enforcement personnel, or security personnel.

18. The method of claim 16, wherein the determined recipient of the notice is an occupant not located within the premises.

19. The method of claim 16, wherein the recipient of the notice is a sensor device located in a room of the premises containing the occupant.

20. The method of claim 16, wherein the collected sensor data indicates an artifact of a hazardous event and the detected event is not a hazardous event.
